(19) United States
(12) Patent Application Publication
(10) Pub. No.: US 2026/0107089 A1
(43) Pub. Date: Apr. 16, 2026

(54) ACOUSTIC DEVICES

(71) Applicant: SHENZHEN SHOKZ CO., LTD., Shenzhen (CN)

(72) Inventors: Wenbing ZHOU, Shenzhen (CN); Yujia HUANG, Shenzhen (CN); Hao KE, Shenzhen (CN); Henghao ZHANG, Shenzhen (CN); Fengyun LIAO, Shenzhen (CN); Xin QI, Shenzhen (CN)

(73) Assignee: SHENZHEN SHOKZ CO., LTD., Shenzhen (CN)

(21) Appl. No.: 19/422,350

(22) Filed: Dec. 16, 2025

Related U.S. Application Data
(63) Continuation of application No. PCT/CN2023/143674, filed on Dec. 29, 2023.

(51) Int. Cl. H04R 1/44; H04R 1/02; H04R 1/08; H04R 1/10

(52) U.S. Cl. CPC H04R 1/44; H04R 1/023; H04R 1/086; H04R 1/1008; H04R 1/1075

(57) ABSTRACT

An acoustic device is provided. The acoustic device comprises a housing, a waterproof assembly, an acoustic assembly, and a sealing member. The housing includes an accommodation cavity provided with a first sound transmission hole. The waterproof assembly is within and in sealed connection with the accommodation cavity, and covers the first sound transmission hole to prevent liquid from contacting an acoustic sensor. The acoustic assembly includes the acoustic sensor, the acoustic assembly being disposed on a side of the waterproof assembly away from the first sound transmission hole and in sealed connection with the waterproof assembly, and a first gap being formed between the acoustic assembly and the accommodation cavity. The sealing member seals the first gap to fix the acoustic assembly and prevent the liquid from entering an interior space of the housing through the first gap.

### CROSS-REFERENCE TO RELATED APPLICATIONS

This application is a Continuation of International Patent Application No. PCT/CN2023/143674, filed on Dec. 29, 2023, the entire contents of which are incorporated herein by reference.

### TECHNICAL FIELD

The present disclosure relates to the technical field of electronic devices, and in particular, to an acoustic device.

### BACKGROUND

A housing of an acoustic device is typically provided with sound transmission holes that allow sound to pass from the external environment into the interior of the acoustic device, or from the interior of the acoustic device to the external environment. When the acoustic device is used outdoors or in a humid environment, liquids such as water can easily enter the device through the sound transmission holes on the housing. For example, a microphone of a wireless earphone must be provided with a sound transmission hole to capture ambient sound and ensure call quality, thereby enabling air-conduction sound transmission. However, when a user engages in underwater activities (such as swimming) while wearing the wireless earphone, water may enter the interior of the earphone through the sound transmission hole. Once water enters, it may not only affect the normal functioning of internal components, such as causing the microphone or loudspeaker to fail, but may also lead to short circuits in the mainboard or certain components, preventing normal use by the user.

Therefore, existing acoustic devices need to take certain measures to improve their waterproof capability, and in particular, enhance the waterproof protection of components such as microphones and loudspeakers.

### SUMMARY

The present disclosure provides an acoustic device comprising a housing, a waterproof assembly, an acoustic assembly, and a sealing member. The housing includes an accommodation cavity, the accommodation cavity being provided with a first sound transmission hole. The waterproof assembly is within the accommodation cavity, the waterproof assembly being in sealed connection with the accommodation cavity and covering the first sound transmission hole to prevent liquid from coming into contact with an acoustic sensor through the waterproof assembly. The acoustic assembly includes the acoustic sensor, the acoustic assembly being disposed on a side of the waterproof assembly away from the first sound transmission hole and in sealed connection with the waterproof assembly, and a first gap being formed between the acoustic assembly and the accommodation cavity. The sealing member seals the first gap to fix the acoustic assembly and prevent the liquid from entering into an interior space of the housing through the first gap.

In some embodiments, the waterproof assembly includes a first adhesive surface and a second adhesive surface. The first adhesive surface is adhesive to adhere the waterproof assembly to the accommodation cavity when external pressure is applied. The second adhesive surface is adhesive to adhere the waterproof assembly to the acoustic assembly when in contact with the acoustic assembly.

In some embodiments, a second gap is formed between the waterproof assembly and the accommodation cavity, and the sealing member further seals the second gap to prevent the liquid from reaching the first gap through the second gap.

In some embodiments, the waterproof assembly includes a waterproof membrane, and at least one cushioning member provided with a center hole. T he at least one cushioning member abuts against an edge region of the waterproof membrane, and an aperture of the first sound transmission hole is less than or equal to an aperture of the center hole, the at least one cushioning member undergoes a target deformation under a force of the acoustic assembly, and the target deformation is less than 50%.

In some embodiments, the acoustic sensor includes at least one microphone configured to receive ambient sound passing through the waterproof assembly; or the acoustic sensor includes at least one loudspeaker, the at least one loudspeaker emits a target sound when operating, and the target sound is transmitted out of the acoustic device through the waterproof assembly.

In some embodiments, the acoustic assembly further includes a flexible printed circuit board, and the flexible printed circuit board is disposed between the acoustic sensor and the waterproof assembly, and mechanically connected to the acoustic sensor. The flexible printed circuit board includes a second sound transmission hole, and the acoustic sensor includes a third sound transmission hole, and the second sound transmission hole and the third sound transmission hole are coaxial.

In some embodiments, an aperture of the third sound transmission hole is not greater than an aperture of the second sound transmission hole, and the aperture of the second sound transmission hole is less than an aperture of the first sound transmission hole.

In some embodiments, the waterproof assembly further includes a gauze mesh, and the gauze mesh is disposed on a side of the waterproof assembly proximate to the first sound transmission hole.

In some embodiments, the waterproof assembly further includes a gauze mesh, and the gauze mesh is disposed on the side of the waterproof assembly away from the first sound transmission hole.

In some embodiments, an inner wall of the housing forms an accommodation side wall of the accommodation cavity; the acoustic assembly further includes a flexible printed circuit board, and the flexible printed circuit board is mechanically connected to the acoustic sensor; and the accommodation side wall is higher than an upper surface of the flexible printed circuit board to form a first accommodation space to accommodate the sealing member.

In some embodiments, the flexible printed circuit board passes over the accommodation side wall via a target segment of the accommodation side wall, and the target segment of the accommodation side wall has a gentler design compared to other portions of the accommodation side wall to reduce a bending degree of the flexible printed circuit board at the accommodation side wall.

In some embodiments, the target segment includes a guiding opening and an inclined guiding surface disposed on the accommodation side wall, and the guiding opening is connected to the inner wall of the housing through the guiding surface to support the flexible printed circuit board.

In some embodiments, the gentler design includes at least one of a rounded-corner design or a sloped design.

In some embodiments, the acoustic sensor includes a first acoustic sensor and a second acoustic sensor. An inner wall of the housing includes a housing bottom wall and a housing side wall. The accommodation cavity includes a first accommodation cavity and a second accommodation cavity, the first accommodation cavity is disposed on the housing bottom wall to accommodate the first acoustic sensor. The second accommodation cavity is disposed on the housing side wall to accommodate the second acoustic sensor, and the first acoustic sensor and the second acoustic sensor are connected through the flexible printed circuit board.

In some embodiments, an aperture of the first sound transmission hole on an inner wall of the housing is smaller than an aperture of the first sound transmission hole on an outer wall of the housing.

In some embodiments, the waterproof assembly is in sealed connection with the accommodation bottom wall of the accommodation cavity, and a center axis of the first sound transmission hole is disposed inclined relative to the accommodation bottom wall.

In some embodiments, the sealing member is obtained by providing a fluid sealing material into the first gap and then curing the fluid sealing material.

In some embodiments, the fluid sealing material is a sealant.

As can be seen from the above technical solutions, the acoustic device provided in the present disclosure makes it impossible for fluid to enter the acoustic sensor by installing the waterproof assembly at the first sound transmission hole, so as to ensure the acoustic performance of the acoustic sensor. By sealing the first gap between the acoustic assembly and the accommodation cavity with the sealing member, the liquid is not allowed to flow into the interior of the housing, which provides waterproof protection for other components in the housing as well as the circuit. The above design improves the waterproofing capability of the acoustic device and safeguards the acoustic performance of the acoustic device.

Other features of the acoustic device provided in the present disclosure will be partially listed in the following description. The creative aspects of the acoustic device described in the present disclosure can be fully understood by practicing or using the methods, devices, and combinations outlined in the detailed examples below.

### BRIEF DESCRIPTION OF THE DRAWINGS

To more clearly illustrate the technical solutions in the embodiments of the present disclosure, the accompanying drawings required to be used in the descriptions of the embodiments will be briefly described below, and it will be apparent that the accompanying drawings in the following descriptions are only some of the embodiments of the present disclosure, and for a person of ordinary skill in the art, other drawings can be obtained based on these drawings without creative labor.

FIG. 1A is a schematic diagram illustrating an exemplary structure of an acoustic device according to some embodiments of the present disclosure;

FIG. 1B is a schematic diagram illustrating an exemplary cross-sectional view of the acoustic device in FIG. 1A along A-A according to some embodiments of the present disclosure;

FIG. 2 is a schematic diagram illustrating an exemplary structure of a portion of an acoustic device according to some embodiments of the present disclosure;

FIG. 3 is a schematic diagram illustrating exemplary structures of two acoustic sensors according to some embodiments of the present disclosure;

FIG. 4 is a schematic diagram illustrating an exemplary structure of a first accommodation cavity according to some embodiments of the present disclosure; and

FIG. 5 is a schematic diagram illustrating a sealing position of a sealing member according to some embodiments of the present disclosure.

### DETAILED DESCRIPTION

The following description provides application-specific scenarios and requirements of the present disclosure, and is intended to enable a person skilled in the art to make and use the contents of the present disclosure. Various local modifications to the disclosed embodiments will be apparent to those skilled in the art and, without departing from the spirit and scope of the present disclosure, the general principles defined herein may be applied to other embodiments and applications. Accordingly, the present disclosure is not limited to the embodiments shown, but rather to the broadest extent consistent with the claims.

The terminology used herein is for the sole purpose of describing particular example embodiments and is not limiting. For example, as used herein, the singular forms “one,” “a,” and “the” may also include plural forms. When used in the present disclosure, the terms “including”, “comprising”, and/or “containing” means that the associated integers, steps, operations, elements, and/or components are present, but does not preclude the presence of one or more other features, integers, steps, operations, elements, components, and/or groups or that other features, integers, steps, operations, elements, components, and/or groups may be added to the system/method.

In the present disclosure, the terms “upper,” “lower,” “left,” “right,” “front,” “back,” “top,” “bottom,” “inside,” “outside,” “vertical,” “horizontal,” “lateral,” and “longitudinal,” etc. indicate an orientation or positional relationship based on the orientation or positional relationship shown in the accompanying drawings. These terms are primarily intended to better describe the present application and its embodiments, and are not intended to qualify that the indicated devices, elements, or components must have a particular orientation, or be constructed and operated in a particular orientation.

Moreover, some of the above terms may be used to denote other meanings in addition to an orientation or positional relationship, for example, the term “upper” may also be used to denote a dependency or connection in some instances. To a person of ordinary skill in the art, the specific meanings of these terms in the present disclosure may be understood on a case-by-case basis.

Additionally, the terms “installing,” “disposing,” “including,” “connecting,” and “connection” are to be understood broadly. For example, the term “connection” may indicate a fixed connection, a removable connection, or an integral construction; may be a mechanical connection, or an electrical connection; may be a direct connection, or an indirect connection through an intermediate medium, or an internal connection between two devices, elements, or components. To a person of ordinary skill in the art, the specific meanings of the above terms in the present disclosure may be understood on a case-by-case basis.

In the present disclosure, the phrase “X includes at least one of A, B, or C” means that X includes at least A, at least B, or at least C. In other words, X may include any one of A, B, or C alone, or any combination of A, B, and C, as well as other possible contents/elements. Any combination of A, B, and C may be A, B, C, AB, AC, BC, or ABC.

In the present disclosure, the terms “or” and “and/or” describe the relationship between associated objects and represent a non-exclusive inclusion. For example, each of “A and/or B” and “A or B” may include: only “A,” only “B,” or both “A” and “B,” where “A” and “B” may be singular or plural. As another example, each of “A, B, and/or C” and “A, B, or C” may include: only “A,” only “B,” only “C,” both “A” and “B,” both “A” and “C,” both “B” and “C,” or all of “A,”“B,”and “C,”where “A,”“B,”and “C”may be singular or plural.

In the present disclosure, the term “plurality”means two or more.

In the present disclosure, unless explicitly stated otherwise, the associative relationship that arises between the structures can be either a direct associative relationship or an indirect associative relationship. For example, when describing “A is connected to B”, unless it is explicitly stated that A is directly connected to B, it should be understood that A can be directly connected to B, or indirectly connected to B; for example, when describing “A is located above B”, unless it is explicitly stated that A is directly located above B (AB is adjacent to and A is located above B), it should be understood that A can be directly located above B, or indirectly located above B (AB is separated from other elements and A is located above B), or the like.

Taking into account the following description, these and other features of the present disclosure, as well as the operation and functioning of the associated elements of the structure, and the economics of combining and fabricating the components, can be significantly improved. Referring to the accompanying drawings, all of which form a part of the present disclosure. It should be clearly understood, however, that the accompanying drawings are used for illustrative and descriptive purposes only and are not intended to limit the scope of the present disclosure. It should also be understood that the accompanying drawings are not to scale.

The present disclosure is described in detail below by way of specific embodiments:

A housing of an acoustic device typically includes a sound transmission hole for allowing sound to pass from the external environment into the interior of the acoustic device, or from the interior of the acoustic device to the external environment. For example, a wireless earphone with call functionality includes a sound transmission hole for the microphone to pick up sound, so as to receive sound transmitted through the air. To ensure that the acoustic device can operate normally when used in outdoor or humid environments and to prevent liquids, such as water, from entering the acoustic device, the sound transmission hole needs to be treated for liquid resistance. The present disclosure provides an acoustic device in which one or more sound transmission holes are treated to enhance the liquid-resistant capability of the acoustic device. In the present disclosure, liquids include but are not limited to water, oil, sweat, or the like. For ease of description, water is used as an example below.

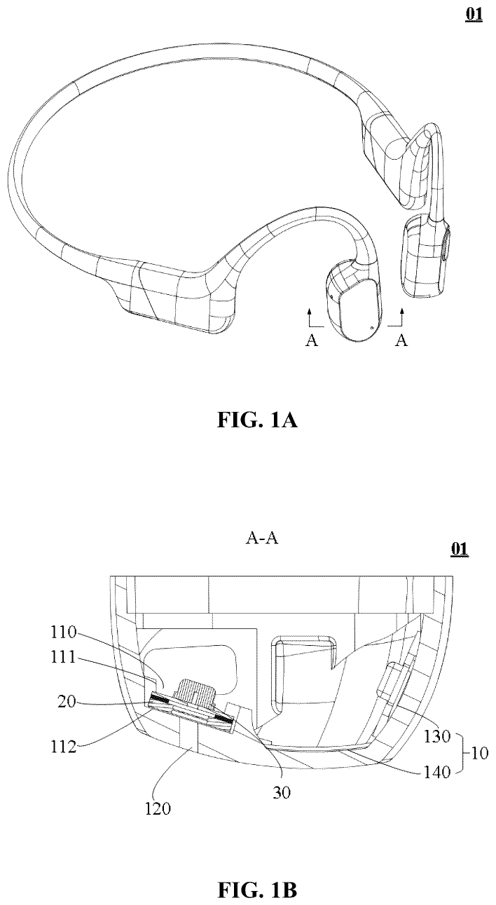

FIG. 1A is a schematic diagram illustrating an exemplary structure of an acoustic device 01 according to some embodiments of the present disclosure. FIG. 1B is a schematic diagram illustrating an exemplary cross-sectional view of the acoustic device 01 shown in FIG. 1A along A-A. The acoustic device 01 illustrated in FIG. 1A is an (wireless) earphone, and all of the following is presented as an example of the acoustic device 01 being the (wireless) earphone, which may be a bone-conducting earphone, an air-conducting earphone, or a bone-air-conducting earphone. It is known that the acoustic device 01 may also be a cell phone, a computer, a tape recorder, or other acoustic devices. The acoustic device 01 may include a housing 10, a waterproof assembly 20, an acoustic assembly 30, and a sealing member 40 (not shown in FIGS. 1A and 1B).

As shown in FIG. 1B, the housing 10 may serve as a mounting assembly of the acoustic device 01, on which other parts of the acoustic device 01 (e.g., the waterproof assembly 20, the acoustic assembly 30, etc.) may be mounted. The housing 10 may include a housing bottom wall 130 and a housing side wall 140, which together enclose an interior space. Other parts of the acoustic device 01 may be disposed within the interior space. The shape of the housing 10 may be any shape, for example, the shape of the housing 10 may be runway-shaped (rounded rectangle) or circular. In some embodiments, when the acoustic device 01 is the wireless earphone, the housing 10 may be shaped to conform to the contours of the human ears, allowing the wireless earphone to be more securely worn on the user's ears. The housing 10 may be made from any material, for example, metal, plastic, polymer, or the like. The present disclosure does not limit the shape and material of the housing 10.

The housing 10 may include an accommodation cavity 110, and the accommodation cavity 110 accommodates other parts such as the acoustic assembly 30. In some embodiments, an inner wall of the housing 10 may form an accommodation side wall 111 and an accommodation bottom wall 112 of the accommodation cavity 110. For example, the housing bottom wall 130 of the housing 10 may form the accommodation bottom wall 112 and the accommodation side wall 111. As another example, the housing bottom wall may form the accommodation bottom wall 112 and a portion of the accommodation side wall 111, and the housing side wall 140 forms another portion of the accommodation side wall 111. In some embodiments, the accommodation cavity 110 may be a space enclosed by other parts.

The accommodation cavity 110 may be provided with a first sound transmission hole 120, e.g., the first sound transmission hole 120 may be opened on the accommodation bottom wall 112 of the accommodation cavity 110. In some embodiments, an aperture of the first sound transmission hole 120 on the inner wall of the housing 10 may be smaller than an aperture of the first sound transmission hole 120 on an outer wall of the housing 10, where the term “aperture” refers to the diameter of an opening formed on a wall. That is to say, the first sound transmission hole 120 may be formed in a flared shaped configuration with a larger outer diameter and a smaller inner diameter. By designing the first sound transmission hole 120 in a flared shape, on the one hand, it facilitates the removal of foreign substances such as solids or liquids that may enter the first sound transmission hole 120, and on the other hand, it allows for smooth demolding during the manufacturing process of the first sound transmission hole 120.

In some embodiments, a center axis of the first sound transmission hole 120 may be inclined relative to the accommodation bottom wall 112, to prevent water from entering the interior of the housing through the first sound transmission hole 120. The center axis of the first sound transmission hole 120 may be a line connecting the center of a first opening of the first sound transmission hole 120 on the inner wall of the housing 10 and the center of a second opening of the first sound transmission hole 120 on the outer wall of the housing 10. An inclination angle of the center axis of the first sound transmission hole 120 with respect to the accommodation bottom wall 112 may be selected according to product design and manufacturing requirements, provided that it does not adversely affect the acoustic performance of the acoustic device 01. In some embodiments, the inclination angle may be in a range of 65 degrees to 80 degrees, which not only ensures a certain degree of inclination but also reduces the machining difficulty of the first sound transmission hole 120. In some embodiments, the inclination angle may be in a range of 35 degrees to 60 degrees, which ensures that the inclination angle in this range can further enhance the ability to prevent water from entering the housing through the first sound transmission hole. In some application scenarios, such as swimming, by disposing the first sound transmission hole 120 inclined, the water flow will not directly rush into the first sound transmission hole 120 when the acoustic device 01 is subjected to dynamic water pressure, thereby improving the waterproof performance of the acoustic device 01 under dynamic water pressure. The shape of the first sound transmission hole 120 may be round, oval, square, rectangular, or the like, which are not limited herein.

In some embodiments, the acoustic device 01 includes a plurality of accommodation cavities 110 to accommodate a plurality of components, respectively. For example, the accommodation cavity 110 may include a first accommodation cavity and a second accommodation cavity, the first accommodation cavity may be disposed on the housing bottom wall 130, and the second accommodation cavity may be disposed on the housing side wall 140 to enable sound transmission holes in different accommodation cavities to receive sound along different directions or transmit sound along different directions. In some embodiments, both the first accommodation cavity and the second accommodation cavity may be disposed on either the housing bottom wall 130 or the housing side wall 140 to enhance the ability of the sound transmission holes to receive sound or transmit sound along the same direction. The first accommodation cavity and the second accommodation cavity may accommodate different components, respectively, as described below.

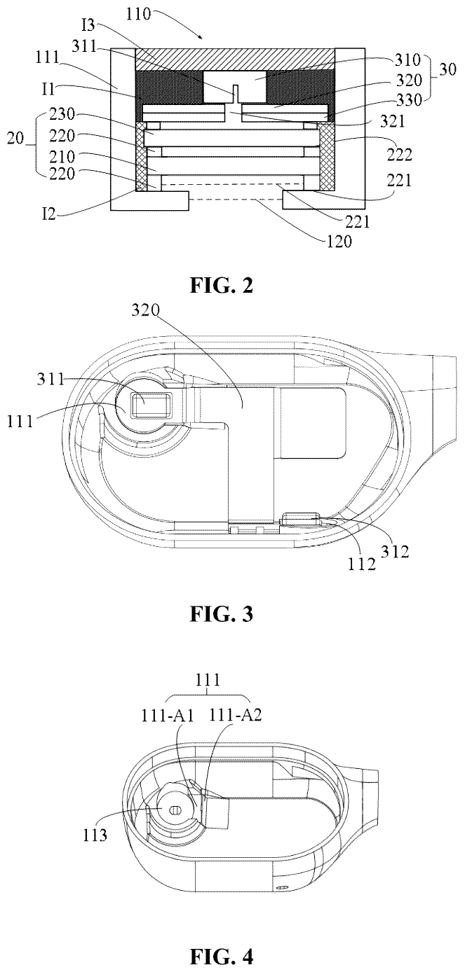

In some embodiments, the acoustic device 01 includes the sealing member 40, and the sealing member 40 may seal assembly gaps between components within the accommodation cavity 110 to enhance the waterproof capability of the acoustic device 01. FIG. 2 is a schematic diagram illustrating an exemplary structure of the accommodation cavity 110 of the acoustic device 01 according to some embodiments of the present disclosure.

As shown in FIG. 2, the waterproof assembly 20 is within and in sealed connection with the accommodation cavity 110, and covers the first sound transmission hole 120 to prevent liquid from contacting components in the acoustic assembly 30 through the waterproof assembly 20. The acoustic assembly 30 is disposed on a side of the waterproof assembly 20 away from the first sound transmission hole 120 and is in sealed connection with the waterproof assembly 20.

In some embodiments, the waterproof assembly 20 may include a waterproof membrane 210 and at least one cushioning member 220. The waterproof membrane 210 may be made of a waterproof and breathable material having an equivalent microporous structure. The waterproof and breathable material is characterized in that air molecules can pass through the equivalent microporous structure, whereas water molecules cannot pass through it. When the acoustic device 01 is in operation, upon reaching the interface of the waterproof membrane 210, air molecules, due to their relatively large intermolecular spacing and small size, can freely pass through the equivalent microporous structure of the waterproof membrane 210. For example, ambient sound waves can pass through the waterproof membrane 210 to be collected by a microphone, or sound waves generated by a loudspeaker can pass through the waterproof membrane 210 to the exterior of the acoustic device 01.

A cushioning member 220 may be provided with a center hole 221, and the cushioning member 220 abuts against an edge region of the waterproof membrane 210. That is, the cushioning member 220 is disposed on at least one side of the waterproof membrane 210 and is connected to the waterproof membrane 210. The cushioning member 220 abuts against the edge region of the waterproof membrane 210. That is, the waterproof membrane 210 completely covers the center hole 221 of the cushioning member 220 such that liquid flowing through the center hole 221 will be blocked by the waterproof membrane 210.

To distinguish between the first sound transmission hole 120 and the center hole 221, apertures of the two are shown with a dotted line in FIG. 2. In some embodiments, openings of the center hole 221 and the first sound transmission hole 120 on the inner wall of the housing 10 are not aligned along the same axis. In some embodiments, the center hole 221 and the opening of the first sound transmission hole 120 on the inner wall of the housing 10 are coaxial, such that the waterproof membrane 210 can be uniformly subjected to the water pressure of the water flowing in from the first sound transmission hole 120. Therefore, the waterproof membrane 210 is less prone to breakage due to uneven water pressure, which results in a reduced waterproofing effect or even failure of the waterproof assembly 20. The shape of the center hole 221 may be round, oval, square, rectangular, or the like, which are not limited herein. In some embodiments, the shape of the center hole 221 is adapted to the shape of the first sound transmission hole 120, and the aperture of the first sound transmission hole 120 may be less than or equal to an aperture of the center hole 221, to allow the waterproof membrane 210 to have a larger area capable of withstanding water pressure, so that breakage is less likely to occur. In some embodiments, the aperture of the center hole 221 may be in a range of 0.8 mm to 1.8 mm. While adapting to an accommodation space of a third accommodation cavity 112 and the aperture of the first sound transmission hole 120, the aperture of the center hole 221 is made larger to increase the area of the second waterproof membrane 121 to withstand water pressure. In some embodiments, the aperture of the first sound transmission hole 120 may be in a range of 0.6 mm to 1.2 mm, and the aperture may be made smaller to reduce the possibility of liquids entering the interior of the housing 10, without affecting the sound pickup of the acoustic device 01. In some embodiments, the waterproof assembly 20 includes an adhesive surface, so that after the waterproof assembly 20 is placed within the accommodation cavity 110, the adhesive surface may adhere to the accommodation bottom wall 112 of the accommodation cavity 110, thus realizing a sealed connection and fixing the waterproof assembly 20. For example, the waterproof assembly 20 may include a first adhesive surface 221 and a second adhesive surface 222. The first adhesive surface 221 may adhere to the waterproof assembly 20 within the accommodation cavity 110 after external pressure is applied. The external pressure may be provided by the gravity of the acoustic assembly 30, may be provided by a pressure jig pressing down on the waterproof assembly 20, or may be provided by a manual force applied by direct contact with the waterproof assembly 20. The second adhesive surface 222 may enable the waterproof assembly 20 and the acoustic assembly 30 to be sealed and adhered when the waterproof assembly 20 and the acoustic assembly 30 are in contact. Specifically, the waterproof assembly 20 may include two cushioning members 220 disposed on two sides of the waterproof membrane 210, respectively. The two sides of the cushioning member 220 facing the accommodation cavity 110 and the acoustic assembly 30 may be adhesive. After the waterproof assembly 20 is within the accommodation cavity 110, a predetermined pressure is applied to the waterproof assembly 20 by a pressure jig, such that the waterproof assembly 20 can be firmly adhered to the accommodation bottom wall 112. By providing the adhesive surface, the waterproof assembly 20 is fixed within the accommodation cavity 110 by means of adhesive bonding, which realizes a waterproof effect and ensures the simplicity and convenience of the operation process.

Further, the cushioning member 220 may also be elastic. The cushioning member 220 is capable of evenly distributing high-velocity physical pressure (impact energy) applied to the waterproof assembly 20, and during the installation of the waterproof assembly 20, the cushioning member 220 can protect the waterproof membrane 210 from wrinkling due to excessive impact, thereby preventing any adverse effects on its waterproof and acoustic performance. In some embodiments, the cushioning member 220 may be made of foam adhesive, elastic acrylic adhesive, or a combination of a foam substrate and elastic acrylic adhesive.

To reduce the difficulty of assembling the waterproof assembly 20, the acoustic assembly 30, and the accommodation cavity 110, dimensions of the waterproof assembly 20 and the acoustic assembly 30 may be slightly smaller than a dimension of the accommodation cavity 110. As illustrated in FIG. 2, a first gap I1 is formed between the acoustic assembly 30 and the accommodation cavity 110, and a second gap I2 is formed between the waterproof assembly 20 and the accommodation cavity 110.

In some embodiments, the waterproof assembly 20 further includes a gauze mesh 230. As shown in FIG. 2, the gauze mesh 230 may be disposed on the side of the waterproof assembly 20 away from the first sound transmission hole 120. When the waterproof membrane 210 encounters a large water pressure, the waterproof membrane 210 may deform. At this time, the gauze mesh 230 may play a supporting or blocking role behind the waterproof membrane 210, thereby avoiding excessive deformation of the waterproof membrane 210. This avoids alterations to the acoustic performance of the waterproof membrane 230 and enhances the waterproof capability of the waterproof membrane 210. At this time, the second adhesive surface 222 may be adhered to the gauze mesh 230. A side of the gauze mesh 230 facing the acoustic assembly 20 may be fixed to the acoustic assembly 20 by adhesion. In some embodiments, the gauze mesh 230 may also be disposed on a side of the waterproof assembly 20 proximate to the first sound transmission hole 120. When a user wears the earphone for an underwater activity and there is a water flow into the acoustic device from the first sound transmission hole 120, the water may flow through the gauze mesh 230 first. The gauze mesh 230 can disperse the water flow through meshes, which can make the impact force on the waterproof membrane 210 more dispersed, so that the force on the waterproof membrane 210 at various places is smaller, and the waterproof membrane 210 is not easy to deform, thereby enhancing the waterproof capability of the waterproof membrane 210 (the waterproof assembly 20).

In some embodiments, the at least one cushioning member 220 undergoes a target deformation under the force of the acoustic assembly 30 when the acoustic assembly 30 is positioned over the waterproof assembly 20. The target deformation is less than 50% because the at least one cushioning member 220 is elastic and can rebound. A deformation degree of the at least one cushioning member 220 may be determined by the formula: (originalthickness−compressedthickness)/originalthickness×100%. For example, the original thickness of the at least one cushioning member 220 is recorded first. When the waterproof assembly 20 is pressed down, the compressed thickness of the at least one cushioning member 220 is recorded, the deformation degree of the at least one cushioning member 220 is obtained.

The acoustic assembly 30 may include an acoustic sensor 310 and a flexible printed circuit (FPC) board 320. The FPC board 320 is flexible and can be bent. By bending the FPC board 320, thereby the space of the housing 10 occupied by the FPC board 320 can be reduced.

The acoustic sensor 310 may include a third sound transmission hole 311. In some embodiments, the acoustic sensor 310 includes at least one microphone, and the at least one microphone includes the third sound transmission hole 311 for receiving ambient sound passed through the waterproof assembly 20. In some embodiments, the acoustic sensor 310 includes at least one loudspeaker, and the at least one loudspeaker includes the third sound transmission hole 311. The at least one loudspeaker may emit a target sound when operating. The target sound may be output from the third sound transmission hole 311, and then transmitted out of the acoustic device 01 through the waterproof assembly 20. As described above, the waterproof assembly 20 covers the first sound transmission hole 120 to prevent water from contacting components in the acoustic assembly 30 through the waterproof assembly 20. Specifically, the waterproof assembly 20 prevents water from contacting the acoustic sensor 310 through the waterproof assembly 20 and prevents water from entering the acoustic sensor 310 through the third sound transmission hole 311.

The FPC board 320 may be mechanically connected to the acoustic sensor 310. The mechanical connection may be achieved by means of adhesion, surface mount technology (SMT) soldering, manual soldering, seam engagement, riveting, or the like. For example, the acoustic sensor 310 may be fixed to the FPC board 320 by soldering. The FPC board 320 may be disposed between the acoustic sensor 310 and the waterproof assembly 20. As described above, the acoustic assembly 30 may be connected to the waterproof assembly 20 by being adhered to the second adhesive surface 222 of the waterproof assembly 20. Specifically, the FPC board 320 may be adhered to the second adhesive surface 222 of the waterproof assembly 20, thereby enabling the acoustic assembly 30 to be connected to the waterproof assembly 20. In some embodiments, further pressure is applied to the acoustic assembly 30 such that the FPC board 320 may be adhered more strongly to the second adhesive surface 220.

In some embodiments, the FPC board 320 may also be subjected to a localized or overall reinforcement; in other words, a localized thickness or hardness of the FPC board 320 may be increased, as well as a flatness of the FPC board 320 maintained. For example, a reinforcement plate 330 made of steel or polyimide (PI) material may be used to reinforce the FPC board 320. The PI material is an engineering plastic with excellent mechanical properties, and is characterized by light weight, thin thickness, and good bending properties. As shown in FIG. 2, the reinforcement plate 330 may be disposed between the FPC board 320 and the waterproof assembly 20. The FPC board 320 may include a second sound transmission hole 321. The second sound transmission hole 321 and the third sound transmission hole 311 may be coaxial, so that the path for sound to travel into or out of the acoustic sensor 310 is the shortest, thereby ensuring that the acoustic sensor 310 has good acoustic performance. In some embodiments, the first opening of the first sound transmission hole 120 on the inner wall of the housing 10 may be coaxial with the second sound transmission hole 321 and the third sound transmission hole 311, so that the path for sound to travel into or out of the acoustic device 01 is the shortest, thereby ensuring that the acoustic device 01 has good acoustic performance. In some embodiments, the first opening of the first sound transmission hole 120 on the inner wall of the housing 10 is not coaxial with the second sound transmission hole 321 and the third sound transmission hole 311, thereby allowing more flexibility in selecting the position of the first sound transmission hole 120 on the housing 10.

In some embodiments, an aperture of the third sound transmission hole 311 may be not greater than the aperture of the second sound transmission hole 321, and the aperture of the second sound transmission hole 321 may be less than the aperture of the first sound transmission hole 120. The aperture of the first sound transmission hole 120 is designed to be larger to increase the sound pressure. For example, the aperture of the first sound transmission hole 120 may be in a range of 0.6 mm to 1.2 mm, the aperture of the second sound transmission hole 321 may be 0.5 mm, and the aperture of the third sound transmission hole 311 may be 0.25 mm.

The accommodation side wall 111 may be higher than an upper surface of the FPC board 320, so that a first accommodation space I3 may be formed to accommodate the sealing member 40, as shown in FIG. 2. In some embodiments, the accommodation side wall 111 of the accommodation cavity 110 is higher than the upper surface of the acoustic sensor 310 so as to form more space to accommodate the sealing member 40.

The acoustic device 01 may include a plurality of acoustic sensors 310 for additional functionality. For example, the acoustic sensor 310 includes two acoustic sensors 310, including a first acoustic sensor 311 and a second acoustic sensor 312. FIG. 3 is a schematic diagram illustrating exemplary structures of two acoustic sensors 310 according to some embodiments of the present disclosure. For example, when the acoustic sensor 310 is a microphone, two microphones disposed in an earphone can realize a noise reduction effect, where one microphone may be a normal microphone used by a user during a call to collect human voice, and the other microphone may be configured with a noise collection function, facilitating the acquisition of ambient noise. As described above, a first accommodation cavity 113 and a second accommodation cavity 114 may accommodate different components, respectively. Specifically, the first accommodation cavity 113 may accommodate the first acoustic sensor 311, and the second accommodation cavity 114 may accommodate the second acoustic sensor 312. Specific structures of the first acoustic sensor 311 and the second acoustic sensor 312 may be the same as those described above. The process by which the first acoustic sensor 311 and the second acoustic sensor 312 are installed within the corresponding accommodation cavities 110 may also be the same as that described above, and will not be repeated here.

The first acoustic sensor 311 and the second acoustic sensor 312 share a single FPC board 320. That is, both the first acoustic sensor 311 and the second acoustic sensor 312 are mechanically connected to the FPC board 320.

In some embodiments, the first acoustic sensor 311 and the second acoustic sensor 312 are mechanically connected to different FPC boards 320. The first acoustic sensor 311 and the second acoustic sensor 312 are connected by mechanically connecting the two FPC boards 320 of the two acoustic sensors 310. The two FPC boards 320 of the two acoustic sensors 310 may be connected by an additional connection circuit board. For example, the connection is realized through a printed circuit board (PCB). The PCB is not easy to bend and has a certain degree of rigidity, and thus can well support the two acoustic sensors 310. As another example, the two FPC boards 320 of the two acoustic sensors 310 may also be electrically connected through board-to-board connectors (BTB connectors). As another example, the two FPC boards 320 of the two acoustic sensors 310 may also be connected through another FPC board. The present disclosure does not limit a connection method of the two acoustic sensors 310 herein.

In some embodiments, the first acoustic sensor 311 and the second acoustic sensor 312 may be connected through the FPC board 320. As described above, the FPC board 320 may be a circuit board shared by the two acoustic sensors 310, as illustrated in FIG. 3, or the two FPC boards 320 of the two acoustic sensors 310 may also be connected through another FPC board.

As described above, the accommodation side wall 111 may be higher than the upper surface of the FPC board 320. Therefore, when the acoustic device 01 includes a plurality of acoustic sensors 310, to connect the plurality of acoustic sensors 310, the FPC board 320 needs to be bent out within the accommodation cavity 110, extend beyond the accommodation cavity 110, pass over the accommodation side wall 111, and then bend to make contact with the housing bottom wall 140, thereby reducing the space of the housing 10 occupied by the FPC board 320. To reduce the bending degree of the FPC board 320 when it passes over the accommodation cavity 110, and to prevent the FPC board 320 from being damaged due to excessive bending at the accommodation side wall 111, the accommodation side wall 111 may be provided with a target segment 111-A, and the FPC board 320 may pass over the accommodation side wall 111 via the target segment 111-A of the accommodation side wall 111. Taking the first accommodation cavity 113 as an example to illustrate the target segment 111-A, the second accommodation cavity 114 may also have the same design. FIG. 4 is a schematic diagram illustrating an exemplary structure of the first accommodation cavity 113 according to some embodiments of the present disclosure.

The target segment 111-A may have a gentler design compared to other portions of the accommodation side wall 111, thereby reducing the bending degree of the FPC board 320 at the accommodation side wall 111 and increasing the service time of the FPC board 320.

For example, while corners of other portions of the accommodation side wall 111 are sharp right angles, the gentler design of the target segment 111-A may be that the corner of the target segment 111-A is a rounded corner. As another example, the corners of other portions of the accommodation side wall 111 are rounded corners at a smaller angle, and the gentler design of the target segment 111-A may be that the corner of the target segment 111-A is a rounded corner at a larger angle. As another example, where other portions of the accommodation side wall 111 have large height differences from the inner wall of the housing 10, the gentler design of the target segment 111-A may be that the target segment 111-A has a smaller height difference from the inner wall of the housing 10 and there is a slope between the inner wall of the housing 10 and the target segment 111-A to support the FPC board 320. As shown in FIG. 4, in some embodiments, the target segment 111-A includes a guiding opening 111-A1 and an inclined guiding surface 111-A2 disposed on the accommodation side wall 111. The upper surface of the FPC board 320 may be flush with an upper surface of the guiding opening 111-A1 such that the FPC board 320 does not have to bend to pass over the accommodation side wall 111. The guiding opening 111-A1 may be connected to the inner wall of the housing 10 through the inclined guiding surface 111-A2. Since there is a certain height difference between the guiding opening and the inner wall of the housing 10, the guiding surface 111-A2 may be provided to support the FPC board 320, preventing the FPC board 320 from being suspended and thereby reducing the risk of damage to the FPC board 320. In some embodiments, the bending degree of the FPC board 320 at the accommodation side wall 111 is measured based on a bending angle of the FPC board 320. The smaller the bending angle, the lower the bending degree. For example, the bending degree when the bending angle is acute is lower than the bending degree when the bending angle is right. Without the guiding surface 111-A2, the FPC board 320 would need to be bent at a right angle along the accommodation side wall 111. As shown in FIG. 4, due to the provision of the inclined guiding surface 111-A2, the FPC board 320 is prevented from forming a sharp bending angle when bending downward. The support of the guiding surface 111-A2 makes the bending angle of the FPC board acute and at a small angle. In some embodiments, compared to the right-angle design of other segments, the target segment 111-A may also be designed with a rounded corner, so that the FPC board 320 does not undergo direct bending when passing over the accommodation side wall 111, thereby improving the service life of the FPC board 320.

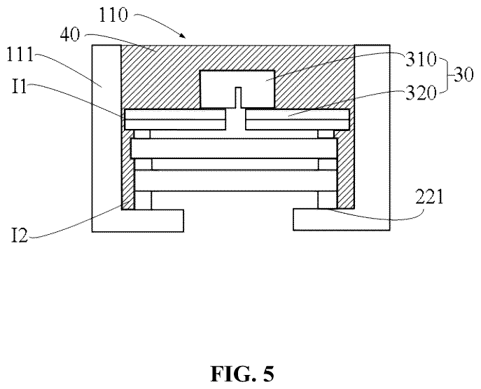

FIG. 5 is a schematic diagram illustrating a sealing position of the sealing member 40 according to some embodiments of the present disclosure. The sealing member 40 is shown in shadow in FIG. 5. The sealing member 40 seals the first gap I1 as shown in FIG. 5. Since the first gap I1 is formed between the acoustic assembly 30 and the accommodation cavity 110, sealing the first gap I1 not only fixes the acoustic assembly 30, but also prevents the liquid from passing through the first gap I1 to the interior space of the housing 10. The sealing member 40 may be obtained by providing a fluid sealing material into the first gap I1 and then curing the fluid sealing material. It should be noted that FIG. 5 is only a schematic diagram illustrating a position of the sealing material after being cured. The fluid sealing material may flow to fill all gaps, so that the components/structures connected with the sealing member 40 are in sealed connection. The fluid sealing material may be a sealant. For example, the sealant may be ultraviolet (UV) curable adhesive, silicone adhesive, hot melt adhesive, or the like.

The sealing member 40 may further seal the second gap I2. Since the second gap I2 is formed between the waterproof assembly 20 and the accommodation cavity 110, and is closer to the waterproof assembly 20 as compared to the first gap I1, sealing the second gap I2 prevents liquid from passing through the second gap I2 into the first gap I1 and thus into the interior of the housing 10. In some embodiments, when the sealing material is UV curable adhesive, the UV curable adhesive may flow into the second gap I2 and then be cured to seal the second gap I2.

As described above, the accommodation side wall 111 may be higher than the upper surface of the FPC board 320, so that a first accommodation space may be formed to accommodate the sealing member 40. In some embodiments, when the sealing material is UV curable adhesive, the UV curable adhesive is applied to the first accommodation space to seal the first accommodation space, further preventing water from entering the interior space of the housing 10. That is, the upper surface of the FPC board 320 and the upper surface of the acoustic sensor 310 may be coated with the UV curable adhesive to allow for a stronger fixing and a tighter sealing between the components and the housing 10.

In summary, the present disclosure provides an acoustic device 01 that has undergone waterproof treatment. By installing the waterproof assembly 20 at the first sound transmission hole 120 of the acoustic device 01, liquid is prevented from entering the third sound transmission hole 311 of the acoustic sensor 310, thereby ensuring the acoustic performance of the acoustic sensor 310. Moreover, the first gap between the acoustic assembly 30 and the accommodation cavity 110 is sealed with the sealing member 40, preventing liquid from entering the interior of the housing 10 and thereby providing waterproof protection for other components and circuits inside the housing 10. The above design improves the waterproof capability of the acoustic device 01 and safeguards the acoustic performance of the acoustic device 01.

The above describes particular embodiments of the present disclosure. Other embodiments are within the scope of the appended claims. In some embodiments, the actions or steps documented in the claims can be performed in a different order than in the embodiments and still achieve the desired results. Additionally, the processes depicted in the accompanying drawings do not necessarily need to be shown in a particular order or consecutive order in order to achieve the desired results. In some implementations, multitasking and parallel processing are also possible or may be advantageous.

In summary, after reading the present detailed disclosure, one of skill in the art can appreciate that the foregoing detailed disclosure may be presented by way of example only and may not be limiting. While not expressly stated herein, a person skilled in the art can understand that the present disclosure needs to encompass a variety of reasonable alterations, improvements, and modifications to the embodiments. These changes, improvements, and modifications are intended to be presented by the present disclosure and are within the spirit and scope of the exemplary embodiments of the present disclosure.

In addition, certain terms in the present disclosure have been used to describe exemplary embodiments of the present disclosure. For example, “an embodiment,” “embodiment,” and/or “some embodiments” means that a particular feature, structure, or characteristic described in conjunction with the embodiment may be included in at least one embodiment of the present disclosure. Accordingly, it may be emphasized and should be understood that the terms “embodiment” or “an embodiment” or “alternative embodiment” in various parts of the present disclosure do not necessarily all refer to the same embodiment. In addition, particular features, structures, or characteristics may be suitably combined in one or more embodiments of the present disclosure.

It should be understood that in the foregoing descriptions of embodiments of the present disclosure, various features have been combined in the present disclosure in a single embodiment, the accompanying drawings, or the descriptions thereof, in order to aid in the comprehension of a feature, and for the purpose of simplifying the present disclosure. However, this is not to say that a combination of these features is necessary, and it is entirely possible that a person skilled in the art could extract some of these features as separate embodiments to be understood when reading the present disclosure. The embodiments described in the present disclosure can also be understood as an integration of multiple sub-embodiments. Each sub-embodiment is also valid when its content includes fewer than all the features of a single previously disclosed embodiment.

All patents, patent applications, patent application publications, and other materials cited in the present disclosure (including but not limited to articles, books, specifications, publications, documents, and reports) are hereby incorporated by reference in their entirety for all purposes. This incorporation expressly excludes: any prosecution file history associated with the referenced materials; any referenced materials that may be inconsistent or conflicting with this document; and any referenced materials that may limit the broadest interpretation of the claims. For example, in the event of any inconsistency or conflict between the descriptions, definitions, and/or use of terms associated with any of the included materials in connection with the present disclosure, the use of the terms in the present disclosure shall prevail.

Finally, it should be understood that the embodiments of the application disclosed herein are illustrations of the principles of the embodiments of the present disclosure. Other modified embodiments are within the scope of the present disclosure. The embodiments disclosed in the present disclosure are therefore intended to be exemplary only and not limiting. The person skilled in the art may adopt alternative configurations based on the embodiments in the present disclosure to realize the application in the present disclosure. As such, the embodiments of the present disclosure are not limited to those embodiments that are precisely described in the application.

What is claimed is:

1. An acoustic device, comprising:
a housing, including an accommodation cavity, the accommodation cavity being provided with a first sound transmission hole;
a waterproof assembly within the accommodation cavity, the waterproof assembly being in sealed connection with the accommodation cavity and covering the first sound transmission hole to prevent liquid from coming into contact with an acoustic sensor through the waterproof assembly;
an acoustic assembly including the acoustic sensor, the acoustic assembly being disposed on a side of the waterproof assembly away from the first sound transmission hole and in sealed connection with the waterproof assembly, and a first gap being formed between the acoustic assembly and the accommodation cavity; and
a sealing member, the sealing member sealing the first gap to fix the acoustic assembly and prevent the liquid from entering an interior space of the housing through the first gap.

2. The acoustic device of claim 1, wherein
the waterproof assembly includes a first adhesive surface and a second adhesive surface;
the first adhesive surface is adhesive to adhere the waterproof assembly to the accommodation cavity when external pressure is applied; and
the second adhesive surface is adhesive to adhere the waterproof assembly to the acoustic assembly when in contact with the acoustic assembly.

3. The acoustic device of claim 1, wherein a second gap is formed between the waterproof assembly and the accommodation cavity, and the sealing member further seals the second gap to prevent the liquid from reaching the first gap through the second gap.

4. The acoustic device of claim 1, wherein the waterproof assembly includes:
a waterproof membrane; and
at least one cushioning member provided with a center hole, wherein the at least one cushioning member abuts against an edge region of the waterproof membrane, an aperture of the first sound transmission hole is less than or equal to an aperture of the center hole, the at least one cushioning member undergoes a target deformation under a force of the acoustic assembly, and the target deformation is less than 50%.

5. The acoustic device of claim 4, wherein the center hole and an opening of the first sound transmission hole on an inner wall of the housing are coaxial.

6. The acoustic device of claim 4, wherein the waterproof assembly includes two cushioning members, the two cushioning members being disposed on two sides of the waterproof membrane, respectively.

7. The acoustic device of claim 4, wherein the acoustic sensor includes at least one microphone configured to receive ambient sound passing through the waterproof assembly; or
the acoustic sensor includes at least one loudspeaker, the at least one loudspeaker emits a target sound when operating, and the target sound is transmitted out of the acoustic device through the waterproof assembly.

8. The acoustic device of claim 4, wherein the acoustic assembly further includes a flexible printed circuit board, and the flexible printed circuit board is disposed between the acoustic sensor and the waterproof assembly, and mechanically connected to the acoustic sensor;
the flexible printed circuit board includes a second sound transmission hole, and the acoustic sensor includes a third sound transmission hole; and
the second sound transmission hole and the third sound transmission hole are coaxial.

9. The acoustic device of claim 8, wherein
an aperture of the third sound transmission hole is not greater than an aperture of the second sound transmission hole; and
the aperture of the second sound transmission hole is less than an aperture of the first sound transmission hole.

10. The acoustic device of claim 4, wherein the waterproof assembly further includes a gauze mesh, and the gauze mesh is disposed on a side of the waterproof assembly proximate to the first sound transmission hole.

11. The acoustic device of claim 4, wherein the waterproof assembly further includes a gauze mesh, and the gauze mesh is disposed on the side of the waterproof assembly away from the first sound transmission hole.

12. The acoustic device of claim 1, wherein an inner wall of the housing forms an accommodation side wall of the accommodation cavity;
the acoustic assembly further includes a flexible printed circuit board, and the flexible printed circuit board is mechanically connected to the acoustic sensor; and
the accommodation side wall is higher than an upper surface of the flexible printed circuit board so as to form a first accommodation space to accommodate the sealing member.

13. The acoustic device of claim 12, wherein the flexible printed circuit board passes over the accommodation side wall via a target segment of the accommodation side wall, and
the target segment of the accommodation side wall has a gentler design compared to other portions of the accommodation side wall to reduce a bending degree of the flexible printed circuit board at the accommodation side wall.

14. The acoustic device of claim 13, wherein the target segment includes a guiding opening and an inclined guiding surface disposed on the accommodation side wall, and the guiding opening is connected to the inner wall of the housing through the guiding surface to support the flexible printed circuit board.

15. The acoustic device of claim 13, wherein the gentler design includes at least one of a rounded-corner design or a sloped design.

16. The acoustic device of claim 1, wherein the acoustic sensor includes a first acoustic sensor and a second acoustic sensor;
an inner wall of the housing includes a housing bottom wall and a housing side wall;
the accommodation cavity includes a first accommodation cavity and a second accommodation cavity, the first accommodation cavity is disposed on the housing bottom wall to accommodate the first acoustic sensor, and the second accommodation cavity is disposed on the housing side wall to accommodate the second acoustic sensor; and
the first acoustic sensor and the second acoustic sensor are connected through the flexible printed circuit board.

17. The acoustic device of claim 1, wherein an aperture of the first sound transmission hole on an inner wall of the housing is smaller than an aperture of the first sound transmission hole on an outer wall of the housing.

18. The acoustic device of claim 1, wherein
the waterproof assembly is in sealed connection with an accommodation bottom wall of the accommodation cavity, and a center axis of the first sound transmission hole is inclined relative to the accommodation bottom wall.

19. The acoustic device of claim 1, wherein the sealing member is obtained by providing a fluid sealing material into the first gap and then curing the fluid sealing material.

20. The acoustic device of claim 19, wherein the fluid sealing material is a sealant.
